(19) United States
(12) Patent Application Publication
(10) Pub. No.: US 2004/0255086 A1
(43) Pub. Date: Dec. 16, 2004

(54) Reader/writer locking protocol

(75) Inventor: Balaji K. Sengdan, Madurai (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/458,288

(22) Filed: Jun. 11, 2003

(51) Int. Cl. G06F 12/00

(52) U.S. Cl. 711/150; 711/151; 711/152

(57) ABSTRACT

A method of controlling access to a shared memory resource. Access is controlled according to a reader/writer lock protocol with a degree of reader/writer starvation set in accordance with a received starvation parameter. An intermediate degree of reader/writer starvation can be achieved by alternating between a reader starvation mode and a writer starvation mode. A new starvation mechanism is also described. The mechanism includes the steps of a) receiving a lock release request; b) determining whether a current lock holder is a reader or a writer; c) releasing the lock and assigning the lock to a waiting reader if step b) determines that the current lock holder is a reader; and d) releasing the lock and assigning the lock to a waiting reader if step b) determines that the current lock holder is a reader.

### FIELD OF THE INVENTION

The invention relates to looking protocols for controlling access to a shared memory resource.

### BACKGROUND OF THE INVENTION

Kernel synchronization primitives are low-level data objects. They support code that synchronizes access to kernel data on shared memory multiprocessor systems. Various types of synchronization objects are available, as the problem of maintaining coherent kernel data does not lend itself to a one-size-fits-all solution. Reader/writer (RW) locks provide mutual-exclusion semantics on a critical region and synchronisation between readers and writers of this region.

The fundamental logic behind RW locks is that a lock can be acquired by more than one reader at the same time, whereas a lock can be acquired only by one writer at a given time.

Based on this logic, the protocols that are generally followed in RW locks are:

(a) A writer will sleep for the lock when the lock is owned by a reader or writer.

(b) A reader will sleep for the look when the lock is owned by a writer.

(c) A reader can acquire the lock when the lock is owned by a reader. Here the lock is shared among different readers and all can access the critical region simultaneously,

However protocol (c) is relaxed at times based on the starvation mechanisms that are explained below.

A corollary of these protocols is:

d) A writer can acquire the lock only when a lock is released by a reader/writer.

e) A reader can acquire the lock when:

1) a lock is released by a reader/writer OR

2) a lock is owned by a reader.

Given these protocols, two methods are commonly used: reader starvation and writer starvation.

In reader starvation methods, a reader is allowed to acquire the lock only after all writers (who requested the lock before or after the reader) acquire the lock, access the critical region and release the lock. Thus, a reader starves for the lock until all writers complete their job.

For example, assume that the lock is owned by a writer (say writer-1). Now if a reader (say reader-1) requests the lock, the reader will sleep. Similarly, consider two more readers (reader-2 and reader-3), who request the lock and sleep. If, after reader-3, a writer (say writer-2) requests the lock, it will sleep too. Similarly, consider three more writers (writer-3, writer-4 and writer-5), who request the lock and sleep.

Then the sequence of readers and writers that requested the lock is:

reader-1, reader-2, reader-3, writer-2, writer-3, writer-4, writer-5

When writer-1 releases the lock, according to the reader starvation mechanism, all readers (reader-1, reader-2 and reader-3) will wait for the lock until writer-2, writer-3, writer-4 and writer-5 have acquired the lock, accessed the critical region and released the lock. Thus reader-1, reader-2 and reader-3 suffer starvation for the lock though they requested the lock before these writers.

In writer starvation methods, a writer is allowed to acquire the lock only after all readers (who requested the lock before or after the writer) acquire the lock, access the critical region and release the lock. Thus, a writer starves for the lock until all readers complete their job.

Consider a similar example to that described above, but with a different sequence of readers and writers that requested the lock. The sequence is now:

writer-2, writer-3, reader-1, writer-4, reader-2, reader-3

When writer-1 releases the lock, according to the writer starvation mechanism, all writers (writer-2, writer-3 and writer-4) will wait for the lock until reader-1, reader-2 and reader-3 have acquired the lock, accessed the critical region and released the lock. Thus writer-2, writer-3 and writer-4 suffer starvation for the lock even though they requested the lock before these readers.

Now let us consider the lock owner to be a reader (say reader-1) and the following is the sequence of writers waiting for the lock:

writer-1, writer-2.

If another reader (say reader-2) requests the lock after writer-2, then according to the writer starvation mechanism reader-2 will acquire the lock even though it requested the lock after writer-2. Thus writer-1 and writer-2 will starve for the look until reader-1 and reader-2 complete their jobs.

The starvation protocols described above force either readers or writers to starve for the lock indefinitely. This causes very poor performance when customer applications are not written in favour of these protocols. That is if an application is written in such a way that equal numbers of readers and writers request the lock in a random sequence then either of these locking protocols will behave badly. There is no flexibility in this design to alternate the lock between readers and writers and thereby achieve a better performance.

This can be further explained by introducing a scale called the “starvation scale” as shown in FIG. 1. “Reader starvation” is at the left extreme and writer starvation is at the right extreme. Obviously, if reader starvation is at the maximum, then writer starvation will be zero at that point. Thus:

R(max) represents maximum reader starvation;

W(max) represents maximum writer starvation;

R(0) represents zero reader starvation; and

W(0) represents zero writer starvation.

When RW locks are used, starvation cannot be avoided. Therefore the starvation has to be in the range between R(max) and W(max).

With prior art methods, starvation can occur at either the R(max) or the W(max) level, but never in the middle of the scale. The extremes of the scale will favour either readers or writers, but not both, thereby producing a poor overall performance.

In prior art methods, the user does not have any control over the RW locking protocols followed inside the kernel. Therefore, the user applications are designed to suit the RW locking protocol that is available in the kernel (either reader starvation or writer starvation). However, as discussed above, not all user applications can be satisfied uniformly by having either a reader or writer starvation protocol. Some applications might benefit but some may suffer from severe starvation, which is certainly not a desired behaviour for those applications.

### SUMMARY OF THE INVENTION

It is therefore an object of the invention to provide an improved reader/writer lock protocol.

A further object of the present invention is to enable greater user control of the degree of reader/writer starvation.

A further object of the present invention is to provide a degree of reader/writer starvation which is between 0% and 100%.

A further object of the present invention is to provide an alternative starvation mechanism which is based on the current lock owner.

The above objects are to be read disjunctively with the object of at least providing the public with a useful choice.

A first aspect of the invention provides a method of controlling access to a shared memory resource, the method including the steps of a) receiving one or more starvation parameters; b) receiving a request; and c) processing the request according to a reader/writer lock protocol with a degree of reader/writer starvation set in accordance with the starvation parameter(s) received in step a).

By utilizing a user controllable starvation parameter in the RW lock protocol, user applications need not be designed to suit the RW locking protocol that is followed inside the kernel. Instead the user can tune the locking protocol and achieve the performance that is needed for the application.

The starvation parameter(s) may set the degree of reader/writer starvation to be 100% reader or writer starvation, but preferably the degree of reader/writer starvation is set at some intermediate percentage value, for instance 50%.

A further aspect of the invention provides a method of utilizing a shared memory resource, the method including the steps of a) submitting one or more starvation parameters to a shared memory resource manager; and b) submitting a request to the shared memory resource manager for processing according to a reader/writer lock protocol with a degree of reader/writer starvation set in accordance with the starvation parameter(s) submitted in step a).

A further aspect of the invention provides a method of controlling access to a shared memory resource, the method including alternating between a reader starvation mode and a writer starvation mode, wherein any conflicts between a particular class of reader and a particular class of writer are resolved in favor of the writer when in the reader starvation mode, and in favor of the reader when in the writer starvation mode.

According to this aspect, an intermediate degree of reader/writer starvation is implemented by alternating between the two modes. The proportion between the two modes may be fixed. Alternatively, the proportion between the two modes may be controllable, for instance by means of one or more starvation parameters.

A further aspect of the invention provides a method of controlling access to a shared memory resource, the method including the steps of a) receiving a lock release request; b) determining whether a current lock holder is a reader or a writer; c) releasing the lock and assigning the lock to a waiting reader if step b) determines that the current lock holder is a reader; and d) releasing the lock and assigning the lock to a waiting writer if step b) determines that the current lock holder is a writer.

### BRIEF DESCRIPTION OF THE DRAWINGS

The invention will now be described by way of example with reference to the accompanying drawings, in which:

FIG. 1 shows a starvation scale;

FIG. 2 shows a starvation scale with a starvation pointer at a first position;

FIG. 3 shows a starvation scale with a starvation pointer at a second position;

FIG. 4 illustrates the relationship between the writer, reader and single starvation scales and pointers;

FIG. 5 shows a writer starvation scale;

FIG. 6 shows a reader starvation scale;

FIG. 7 shows a single starvation scale;

FIG. 8 is a flow diagram illustrating a RW locking protocol algorithm;

FIG. 9 is a flow diagram illustrating the lock acquire operation, which is part of the algorithm of FIG. 8;

FIG. 10 is a flow diagram illustrating the lock release operation, which is part of the algorithm of FIG. 8; and

FIG. 11 is a schematic block diagram of a shared memory multiprocessor system.

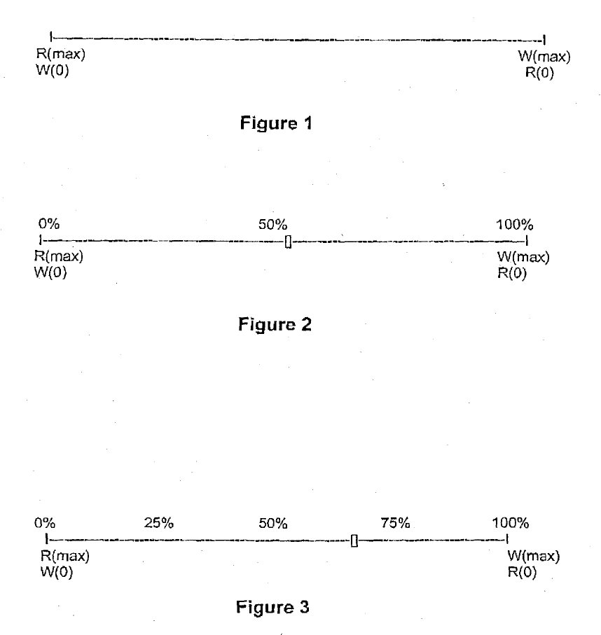

### DETAILED DESCRIPTION OF EMBODIMENTS OF THE INVENTION

Consider the starvation scale shown in FIG. 2, in which:

R(max) represents maximum reader starvation;

W(max) represents maximum writer starvation;

R(0) represents zero reader starvation;

W(0) represents zero writer starvation; and

□ is the “starvation pointer”.

In FIG. 2, the starvation is also shown in percentage terms. The starvation pointer is placed at 50% on the scale. The RW locking protocol described below can provide 50% reader starvation and 50% writer starvation (as is the case when the starvation pointer is at 50%), or any other proportion as desired. The starvation pointer is controlled by the user and it can be placed anywhere on the scale based on the interests of a user and the needs of his or her applications.

For example, if a user wants to achieve 30:70 reader:writer starvation for an application, then the starvation pointer can be placed appropriately on the starvation scale as shown in FIG. 3.

Thus, the starvation pointer serves as a key to inform the kernel regarding the desired behaviour of the RW locking protocol.

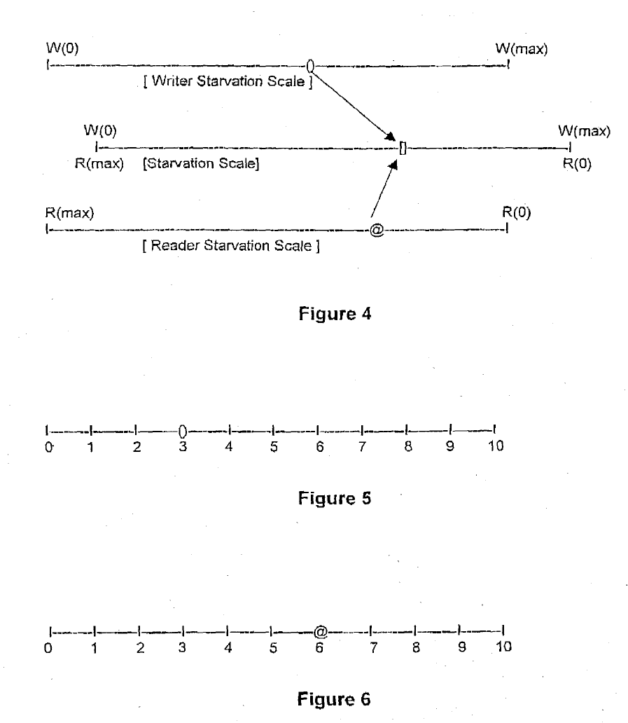

However using the starvation pointer to decide the behaviour of the locking protocol is not ideal, because the starvation pointer represents starvation as a percentage rather than based on the actual situation, which varies dynamically. Ideally the kernel should use parameters that match the starvation pointer and thereby design the locking protocol. Since the kernel cannot derive these parameters using the value of the starvation pointer, the parameters should be user controllable variables, which we will call tunables. Thus the starvation scale can be expanded into two different scales namely a “Reader Starvation Scale” and a “Writer Starvation Scale” as shown in FIG. 4.

Since the starvation scale is now broken down into two different starvation scales, the starvation scale will hereafter be termed the “single starvation scale”. The “single starvation scale” is derived from the combination of the reader starvation scale and the writer starvation scale. The reader/writer starvation scales are very similar to the single starvation scale and they too have starvation pointers: a reader starvation pointer (represented by @) and a writer starvation pointer (represented by ( )). The position of the single starvation pointer □ in the single starvation scale will be derived based on the relative proportion of the writer and reader starvation pointers, ( ) and @.

In general, starvation will cause a reader or writer to wait for a certain number of units (clock ticks, seconds, hours, number of readers or writers acquiring the lock etc.). Therefore it is useful to measure each scale in some form of units. So, if a user wants any writer to wait for 3 units before acquiring the lock, then the starvation pointer can be placed on the scale relative to the maximum value. For example, let us assume the maximum value to be 10 units on both the writer starvation scale (as shown in FIG. 5) and the reader starvation scale (as shown in FIG. 6).

As described above, the single starvation pointer □ will be derived from the combination of the writer and reader starvation pointers ( ) and @. As the single starvation pointer □ should be represented in terms of percentage, we can use a simple ratio calculation to derive the single starvation pointer □ from the writer and reader starvation pointers ( ) and @.

Let us consider the example shown in FIGS. 5 and 6, where the position of the writer starvation pointer (writer_starvation, W) is 3 and the position of the reader starvation pointer (reader_starvation, R) is 6. Then the ratio of reader starvation pointer position to writer starvation pointer position is 6:3.

To calculate the single starvation pointer position the following formulae are used:

Reader starvation as percentage=(100/(R+W))*R

Writer starvation as percentage=(100/(R+W))*W

The single starvation pointer on the single starvation scale can be plotted based on the above two values.

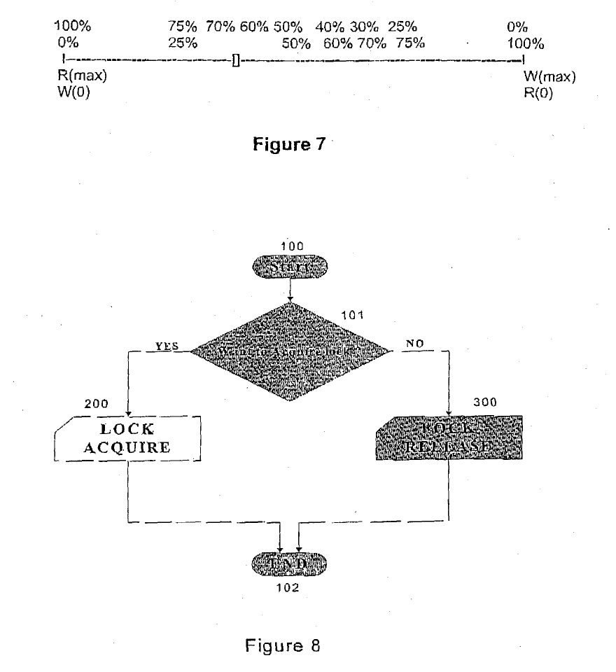

The reader starvation is (100/9)*6 which is 66.66%. The writer starvation is (100/9)*3 which is 33.33%. The single starvation pointer on the single starvation scale is shown in FIG. 7.

Thus the user controllable starvation scales are now the “reader starvation scale” and the “writer starvation scale” and not the single starvation scale. Similarly the user controllable parameters are “reader starvation in units” and “writer starvation in units” and not the single starvation pointer. The single starvation scale and its starvation pointer are automatically derived by the kernel using these parameters.

Based on the method described above, three variants of the starvation mechanism could be followed.

Variant 1: Current Lock Owner Based Starvation

It is complex to visualize the derivation of a single starvation pointer based on two user controllable parameters which are exactly complementary to each other. For example, zero reader starvation essentially means a maximum writer starvation. Since both are user controllable parameters, ideally both can be assigned the same value which complicates the issue. For example,

If a user sets reader_starvation to 0 units and writer_starvation to 0 units, then according to the formulae,

reader starvation as percentage=(100/0)*0, which is indeterminate; and

writer starvation as percentage=(100/0)*0, which is also indeterminate.

Since these values are indeterminate, the single starvation pointer cannot be plotted on the single starvation scale. This problem is resolved by “current lock owner based starvation”.

Essentially reader_starvation=writer_starvation=0 shows the interest of the user in not having any starvations, which is practically impossible. Therefore, this special case is handled by the current lock owner. If the current owner of the lock is a writer and if the user controllable parameters are set to 0, then the current owner (writer) will always wakeup another waiting writer and any waiting reader will wait until all waiting writers are woken up. This essentially creates a reader starvation. Similarly if the current lock owner is a reader, then it creates writer starvation.

The essence of this starvation mechanism is that the current lock owner will always wakeup any sleepers of the same type.

Variant 2: Guaranteed Reader/Writer Starvation

This mechanism is provided to maintain compatibility with the prior art methods, where either reader starvation or writer starvation is achieved. To achieve a full time guaranteed reader/writer only starvation, the parameters should be set in such a way that one of the values is zero, while the other is non-zero.

For example, if reader_starvation is set to 0 and writer_starvation is set to 10 (any value greater than 0) then according to the formulae

reader starvation in percentage=(100/10)*0 which is 0%; and

writer starvation in percentage=(100/10)*10 which is 100%.

Then the single starvation pointer will be plotted at W(max), creating a guaranteed writer starvation. Similarly, if writer_starvation is set to 0 and reader_starvation to a non-zero value, then guaranteed reader starvation can be achieved.

Variant 3: Scalable Starvation

This is considered to be the best starvation mechanism, where reader or writer starvation is scalable and is fully controllable by the user. Reader and writer starvation can be minimized at the same time and the lock can be alternated between readers and writers periodically, thus gaining a better overall performance.

For example, if reader_starvation is set to 3 and writer_starvation is set to 2, then according to the formulae:

reader starvation as percentage=(100/5)*3=60%; and

writer starvation as percentage (100/5)*2=40%.

So a reader will starve more than a writer. However, a reader will be allowed to starve only for three units, after which a reader will acquire the lock. Similarly a writer will be allowed to starve only for two units after which a writer will acquire the lock. Within these starvation periods, a writer may allow a reader to acquire the lock and vice versa. Effectively the lock is alternated between a reader starvation mode and a writer starvation mode based on the values of the parameters.

Any writer will starve for the lock when it can allow readers to acquire the lock during that time. Similarly any reader will starve for the lock when it can allow writers to acquire the lock during that time. Therefore the user can decide upon the number of readers which a writer can allow so that the writer will starve for desired number of units. The same applies to a reader.

This mechanism can be utilized by the user to achieve desired performance.

The above mentioned starvation variants can be implemented by the kernel using an algorithm shown in FIGS. 8-10. However, before describing the algorithm in detail, two alternative parameter sets will be described: firstly an “operation” based set, and secondly a “time” based set.

“Operations Based Parameter Set

a) allowed_readers: A writer can allow “allowed_readers” number of readers to acquire the lock before it can acquire the lock. This will result in a writer starvation period of “writer_starvation” units. Thus “writer_starvation” is related to “allowed_readers”.

b) allowed_writers: A reader can allow “allowed_writers” number of writers to acquire the lock before it can acquire the lock. This will result in a reader starvation period of reader_starvation” units. Thus “reader_starvation” is related to “allowed_writers”.

In order to validate the above parameters, the kernel would maintain two internal variables, such as:

c) reader_count: The number of readers that had acquired the lock, since the lock is released by a writer for a reader. This will be used to compare with “allowed_readers”

d) writer_count: The number of writers that had acquired the lock since the lock is released by a reader for a writer. This will be used to compare with “allowed_writers”.

In the algorithm, whether writers are allowed to acquire the lock next will be checked by asking if allowed_writers>0. Similarly, whether readers are allowed to acquire the lock next will be checked by asking if allowed_readers>0.

Also, whether a waiting reader can allow another writer to acquire the lock will be checked by asking if writer_count<allowed_writers. Similarly, whether a waiting writer can allow another reader to acquire the lock will be checked by asking if reader_count<allowed_readers.

When a reader acquires the lock, reader_count will be incremented by one and writer_count will be set to 0. When a writer acquires the lock, writer_count will be incremented by one and reader_count will be set to 0.

“Time” Based Parameter Set

Alternatively, the algorithm could be implemented by considering the starvation period in time as clock ticks. Then the user controllable parameters “reader_starvation” and “writer_starvation” could be directly implemented in terms of clock ticks. The user controllable parameters might then be.

a) writer_wait_time: A writer can wait for the lock for a maximum of “writer_wait_time” clock ticks, within which it can allow any number of readers to acquire the lock. This is equivalent to “writer_starvation” in the writer starvation scale.

b) reader_wait_time: A reader can wait for the lock for a maximum of “reader_wait_time” dock ticks, within which it can allow any number of writers to acquire the lock. This is equivalent to “reader_starvation” in the reader starvation scale.

In order to validate these parameters, the kernel would maintain a variable named “lock_acquired_time”, which is the time that a lock is acquired by either a reader or a writer. This variable would be updated when a reader acquires a lock from a writer or when a writer acquires a lock from a reader.

Thus, whether writers are allowed to acquire the lock next can be checked by asking if reader_wait_time>0. Similarly, whether readers are allowed to acquire the lock next can be checked by asking if writer_wait_time>0.

Whether a waiting reader can allow another writer to acquire the lock can be checked by asking if current_time−lock_acquired_time<reader_wait_time. Current time is the current system time in clock ticks. Similarly whether a waiting writer can allow another reader to acquire the lock can be checked by asking if current_time−lock acquired_time<writer_wait_time.

Thus the algorithm could be implemented using either of these two sets of parameters. Other parameters might also be suitable.

The algorithm will now be described in detail with reference to FIGS. 8-10. The algorithm is distributed between “lock acquire” operation and “lock release” operations, since a reader has to follow the starvation mechanism even during the lock acquire operation. This relationship is illustrated in FIG. 8. From the start 100, the algorithm asks whether the reader or writer wishes to acquire the lock at step 101. If so, then the lock acquire operation is instigated at step 200. If not, then the reader or writer must wish to release the lock and the lock release operation is instigated at step 300. Once the relevant operation is complete the algorithm ends at step 102.

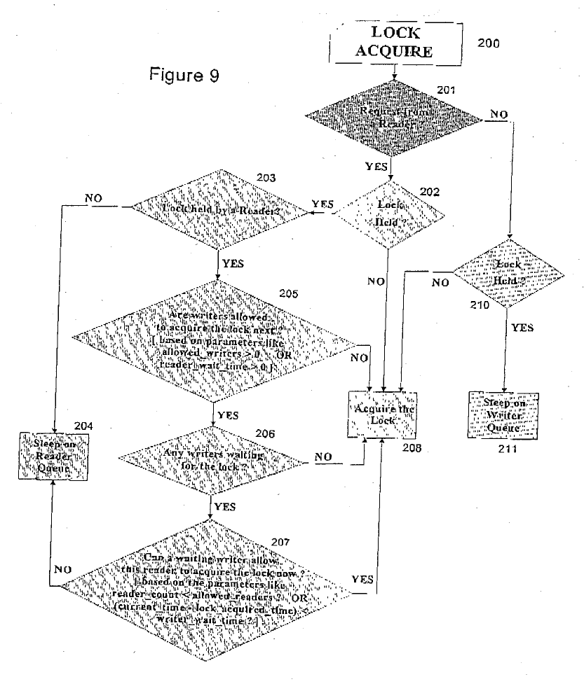

The lock acquire operation will now be described with reference to FIG. 9.

a) If the lock is not held at step 202 or 210, then the lock will be acquired.

b) If the lock is requested by a reader (say reader 1) at step 201 and the lock is owned by another reader (say reader 2) at step 203, then reader 1 will sleep for the lock on a readers' queue (step 204) if the following conditions are true:

(i) writers are allowed to acquire the lock next (step 205),

(ii) writers are waiting for the lock (step 206); and

(iii) a waiting writer cannot allow this reader to acquire the lock now (step 207).

If any of the above conditions is not true, reader 1 will acquire the lock at step 208.

c) If the lock is requested by a reader (step 201) and the lock is owned by a writer (step 203), then the reader will sleep for the lock on a readers' queue (step 204).

d) If the lock is requested by a writer (step 201) and is owned by a reader (step 210) then the writer will sleep for the lock on the writers' queue (step 211).

e) If the lock is requested (step 201) by a writer (say writer 1) and the lock is owned (step 210) by another writer (say writer 2), then writer 1 will sleep for the lock on the writers' queue (step 211).

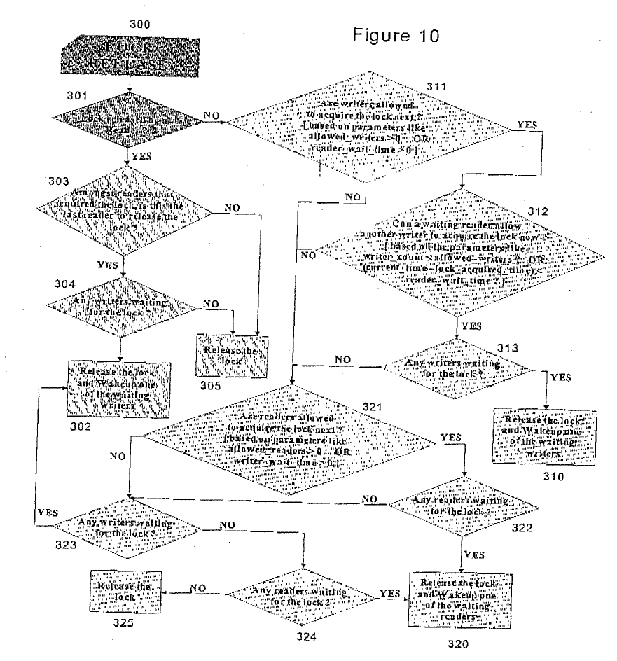

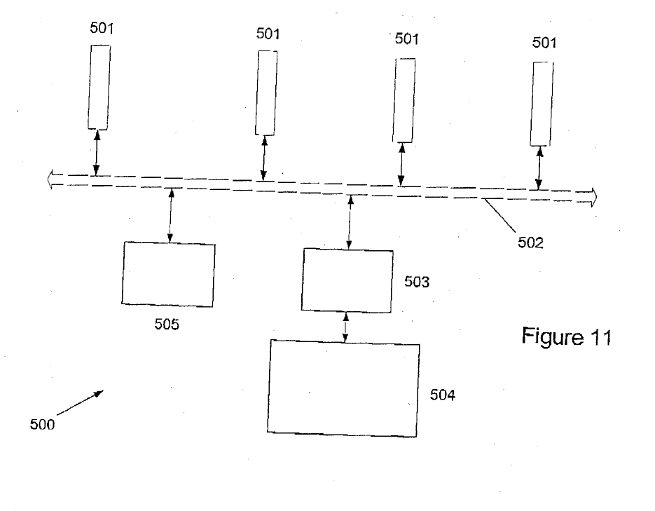

The lock release operation will now be described with reference to FIG. 10.

a) If a lock is released by a reader at step 301, then one of the writers that is waiting for the lock will be woken up (step 302) if the following conditions are true:

(i) amongst the readers that acquired the lock, this is the last reader to release the lock (step 303); and

(ii) writers are waiting for the lock in writers' queue (step 304).

Note that when the selected sleeping writer is “woken up” it acquires the lock.

If either of these conditions is not true then the lock will be released, without performing any wakeup operation.

b) If a lock is released by a writer (step 301), then one of the writers that are waiting for the lock will be woken up (step 310) if the following conditions are true:

(i) writers are allowed to acquire the lock next (step 311);

(ii) a waiting reader can allow another writer to acquire the lock now (step 312); and

(iii) writers are waiting for the lock in the writers' queue (step 313).

If any of the above conditions is not true, then the readers that are waiting for the lock will be woken up (step 320) if the following conditions are true:

(i) readers are allowed to acquire the lock next (step 321); and

(ii) readers are waiting for the lock in the readers' queue (step 322).

If either of these conditions is not true, then one of the writers that are waiting for the lock will be woken up (step 302). If no writers are waiting (step 323), then readers that are waiting for the lock will be woken up (step 320) If no readers are waiting (step 324), then the lock will be released (step 325).

FIG. 11 shows a block diagram of a multiprocessor system 500 suitable for implementation of the above algorithm. FIG. 11 is intended to give one example of a system for implementing the algorithm. However, in practice, a variety of alternative arrangements may be used. The various entities shown in FIG. 11 may be implemented in hardware, or may be software entities or any other means.

A plurality of processors 501 are connected to a communication channel 502. The processors 501 send various requests to a resource manager 503. The requests may be reader lock acquire requests, writer lock acquire requests, lock release requests, or a mixture thereof depending on the application being run by the processor. The resource manager 503 implements the algorithm, and is connected to the communication channel 502 and to a shared memory resource 504. A clock 505 is also connected to the communication channel 502.

Many other systems may also be suitable for implementation of the method of the invention. For example, the manager 503 and the shared memory resource 504 could be connected only via the communication channel 502, and the clock 505 could be connected directly to the resource manager 503.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

What is claimed is:

1. A method of controlling access to a shared memory resource, the method including the steps of a) receiving one or more starvation parameters; b) receiving a request; and c) processing the request according to a reader/writer lock protocol with a degree of reader/writer starvation set in accordance with the starvation parameter(s) received in step a).

2. A method according to claim 1, wherein the request is a lock acquisition request from a new reader when a lock is being held by a current reader, and a waiting writer is being held in a queue, and the step c) includes the substeps of c1) determining whether the waiting writer can allow the new reader to acquire the lock, the determination being made in accordance with the starvation parameter; and c2) assigning the lock to the new reader if the determination made in step c1) is positive.

3. A method according to claim 1, wherein the request is a lock acquisition request from a new reader when a lock is being held by a current reader, and a waiting writer is being held in a queue, and the step c) includes the substeps of c1) determining whether the waiting writer can allow the new reader to acquire the lock, the determination being made in accordance with the starvation parameter; and c2) placing the new reader in a queue if the determination in step c1) is negative.

4. A method according to claim 1, wherein the request is a lock acquisition request from a new reader when a lock is being held by a current reader, and a waiting writer is being held in a queue, and the step c) includes the substeps of c1) determining whether the waiting writer can allow the new reader to acquire the lock, the determination being made in accordance with the starvation parameter; c2) assigning the lock to the new reader if the determination made in step c1) is positive; and c3) placing the new reader in a queue if the determination in step c1) is negative.

5. A method according to claim 1, wherein the request is a lock acquisition request from a new reader when a lock is being held by a current reader, and a waiting writer is being held in a queue, and the step c) includes the substeps of c1) determining whether the waiting writer is allowed to acquire the lock next, the determination being made in accordance with the starvation parameter; and c2) assigning the lock to the new reader if the determination made in step c1) is negative.

6. A method according to claim 1, wherein the request is a lock acquisition request from a new reader when a lock is being held by a current reader, and a waiting writer is being held in a queue, and the step c) includes the substeps of c1) determining whether the waiting writer is allowed to acquire the lock next, the determination being made in accordance with the starvation parameter, and c2) placing the new reader in a queue if the determination in step c1) is positive.

7. A method according to claim 1, wherein the request is a lock acquisition request from a new reader when a lock is being held by a current reader, and a waiting writer is being held in a queue, and the step c) includes the substeps of c1) determining whether the waiting writer is allowed to acquire the lock next, the determination being made in accordance with the starvation parameter; c2) assigning the lock to the new reader if the determination made in step c1) is negative; and c3) placing the new reader in a queue if the determination in step c1) is positive.

8. A method according to claim 1, wherein step c) includes the substeps of c1) selecting either a waiting reader or a waiting writer in accordance with the starvation parameter; and c2) releasing the lock and assigning the lock to the waiting reader or waiting writer selected in substep c1).

9. A method according to claim 1, wherein the request is a lock release request made when a waiting reader and a waiting writer are being held in a queue, and the step c) includes the substeps of c1) determining whether the waiting reader can allow the waiting writer to acquire the lock, the determination being made in accordance with the starvation parameter; c2) releasing the lock and assigning the lock to the waiting writer if the determination made in step c1) is positive; and c3) releasing the lock and assigning the lock to the waiting reader if the determination made in step c1) is negative.

10. A method according to claim 1 wherein step a) includes receiving a reader starvation value and a writer starvation value; and wherein step c) includes processing the request according to a reader/writer lock protocol with a degree of reader/writer starvation set in accordance with the reader starvation value and the writer starvation value.

11. A method according to claim 1 wherein the starvation parameter determines a number of units during which a first class of computation agent will permit a second class of computation agent to acquire a lock which provides access to the shared memory resource.

12. A method according to claim 11 wherein the units are clock cycles.

13. A method according to claim 11 wherein the units are lock acquisition steps.

14. A method according to claim 11 wherein the first class of computation agent is a reader class and the second class of computation agent is a writer class.

15. A method according to claim 11 wherein the first class of computation agent is a writer class and the second class of computation agent is a reader class.

16. A method of utilizing a shared memory resource, the method including the steps of a) submitting one or more starvation parameters to a shared memory resource manager; and b) submitting a request to the shared memory resource manager for processing according to a reader/writer lock protocol with a degree of reader/writer starvation set in accordance with the starvation parameter(s) submitted in step a).

17. A method according to claim 16 wherein step a) includes submitting a reader starvation value and a writer starvation value.

18. A method of controlling access to a shared memory resource, the method including alternating between a reader starvation mode and a writer starvation mode, wherein any conflicts between a particular class of reader and a particular class of writer are resolved in favor of the writer when in the reader starvation mode, and in favor of the reader when in the writer starvation mode.

19. A method according to claim 18 wherein the particular class of reader is a new reader making a lock acquisition request, and the particular class of writer is a waiting writer being held in a queue.

20. A method according to claim 18 wherein the particular class of reader is a waiting reader being held in a queue, and the particular class of writer is a waiting writer being held in a queue.

21. A method of controlling access to a shared memory resource, the method including the steps of a) receiving a lock release request; b) determining whether a current lock holder is a reader or a writer; c) releasing the lock and assigning the lock to a waiting reader if step b) determines that the current lock holder is a reader; and d) releasing the lock and assigning the lock to a waiting writer if step b) determines that the current lock holder is a writer.

22. A computer program product, including a computer-readable medium having stored thereon computer executable instructions for performing the method of claim 1.

23. A computer program product, including a computer-readable medium having stored thereon computer executable instructions for performing the method of claim 16.

24. A computer program product, including a computer-readable medium having stored thereon computer executable instructions for performing the method of claim 18.

25. A computer program product, including a computer-readable medium having stored thereon computer executable instructions for performing the method of claim 21.

26. A resource manager for controlling access to a shared memory resource, the resource manager being configured to perform the method of claim 1.

27. A resource manager for controlling access to a shared memory resource, the resource manager being configured to perform the method of claim 18.

28. A resource manager for controlling access to a shared memory resource, the resource manager being configured to perform the method of claim 21.

29. A processor for utilizing a shared memory resource, said processor being configured to perform the method of claim 16.

30. A computer program configured to perform the method of claim 1.

31. A computer program configured to perform the method of claim 16.

32. A computer program configured to perform the method of claim 18.

33. A computer program configured to perform the method of claim 21.
